(19) United States
(12) Patent Application Publication
(10) Pub. No.: US 2008/0319791 A1
(43) Pub. Date: Dec. 25, 2008

(54) METHOD OF PROVIDING VISION CARE SERVICES AND RETAIL OPTICAL GOODS

(76) Inventor: MITCHELL GOODMAN, Lawrenceville, GA (US)

Correspondence Address: William H. Honaker;Dickinson Wright PLLC, Ste. 2000, 38525 Woodward Avenue, Bloomfield Hills, MI, 48304-2970, US

(21) Appl. No.: 12/141,405

(22) Filed: Jun. 18, 2008

Related U.S. Application Data
(60) Provisional application No. 60/945,624, filed on Jun. 22, 2007.

(51) Int. Cl. G06Q 50/00; G06Q 10/00

(52) U.S. Cl. 705/2

(57) ABSTRACT

A method for providing optometry services and retail optical goods (38) to patients in a package (20) includes establishing a optical management entity (22) owned by a first group of owners and establishing a professional services entity (56) owned by a second group of owners all different from the first group of owners. The optical management entity (22) stocks and sells retail optical goods (38) for the patients, and the professional services entity (56) performs eye examinations (76) on the patients and issues prescriptions (84) for the retail optical goods (38). The optical management entity (22) distributes the retail optical goods (38) to the patients in response to the prescriptions (84). The method includes establishing a combined retail optical goods (38) and eye examination (76) package (20) by the two entities (22, 56) at a package fee (78) for the patients to purchase eye examinations (76) and retail optical goods (38) at the package fee (78).

### CROSS REFERENCE TO RELATED APPLICATION

This application claims the benefit of U.S. provisional patent application Ser. No. 60/945,624 filed Jun. 22, 2007.

### BACKGROUND OF THE INVENTION

1. Field of the Invention

The subject invention relates to a method for providing optometry services and optical goods to patients in a package.

2. Background Information

It is known that optometry services and the retail sale of retail optical goods when combined can provide convenient one stop shopping for eye care needs, and can reduce the cost of the services and goods which in turn provides the patients with lower costs. The convenience of the related services also makes it more likely that patients will get the services and retail optical goods that they require. Once the patient is in an office to have an eye examination, the patient can easily obtain the retail optical goods such as eyeglasses, contacts etc. from the same location without the need to visit a separate facility. This is particularly important to lower income families who have difficulty traveling to various locations. For some lower income families, this difficulty may result in a decision not to obtain needed optometry services or retail optical goods.

Although there are advantages to combining optometry services and the retail sale of optical goods, many states have legislation that prohibits a business from combining both, particularly at the same location. These states require that the optometry services remain independent to ensure that the optometrist retains exclusive control and authority over all clinical and medical matters. Because of these state limitations on arrangements between retail optical firms and optometrists, a combination of optometry services and retail sale of optical goods is impractical.

It is known in the prior art to establish an optical management entity owned by a first group of owners in accordance with the laws of a founding state to stock and sell retail optical goods for the patients by the optical management entity. It is further known to establish a first professional services entity owned by a second group of owners all different from the first group of owners in accordance with the laws of a first licensing state to perform eye examinations on patients and issue prescriptions for the retail optical goods. The optical management entity then distributes the retail optical goods to the patients in response to the prescriptions written by the optical management entity.

Although the prior art provides for a method of obtaining retail optical goods and eye examinations from separate entities, better methods of doing business can more effectively serve patients.

### SUMMARY OF THE INVENTION

The subject invention provides for such a method by establishing a combined retail optical goods and eye examination package by the different legal entities at a package fee for the patients to purchase eye examinations and retail optical goods at the package fee.

The invention also provides a system that establishes and operates legally distinct retail optical goods and eye examination facilities by different legal entities by use of a combined package transaction for the patients to purchase eye examinations and retail optical goods at a combined package fee.

The retail optical goods facility and eye examination facility are not only legally distinct but also physically distinct from one another. The physical distinctness is maintained even in the optional embodiment of the two facilities being located adjacent (or even contiguous with) one another.

Accordingly, the subject invention provides a method of providing optometry services and retail sale of optical goods at a single location while maintaining the optometry services as an independent service which retains exclusive control and authority over all clinical and medical matters.

### BRIEF DESCRIPTION OF THE DRAWINGS

Other advantages of the present invention will be readily appreciated, as the same becomes better understood by reference to the following detailed description when considered in connection with the accompanying drawings wherein:

FIGS. 1A-1E show a flow chart of a first embodiment of the subject invention;

FIG. 2 is a flow chart of a second embodiment of the subject invention;

FIG. 3 is a schematic of the organizational and operational attributes of an optical management entity;

FIG. 4 is a schematic of the organizational and operational attributes of a first professional services entity;

FIG. 5 is an operational flow diagram showing the operational relationship between all the entities; and

FIG. 6 is a block diagram showing the architectural relationships of the various entities of a system according to an embodiment of the present invention.

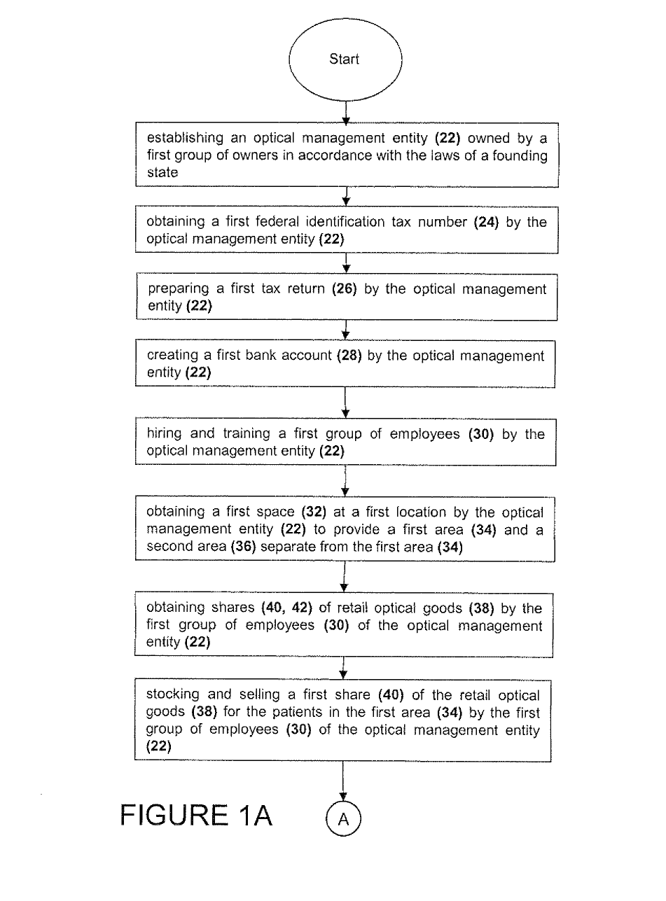

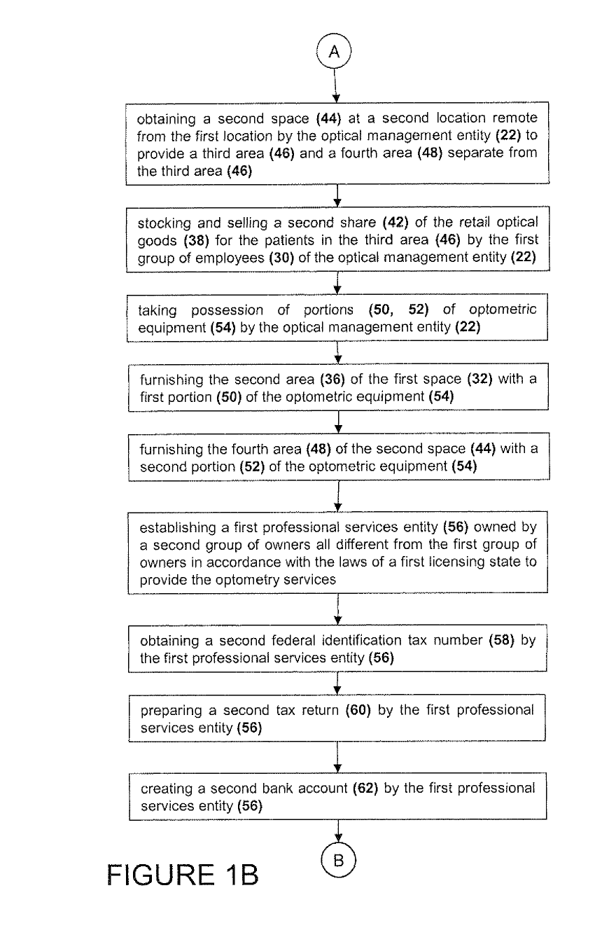

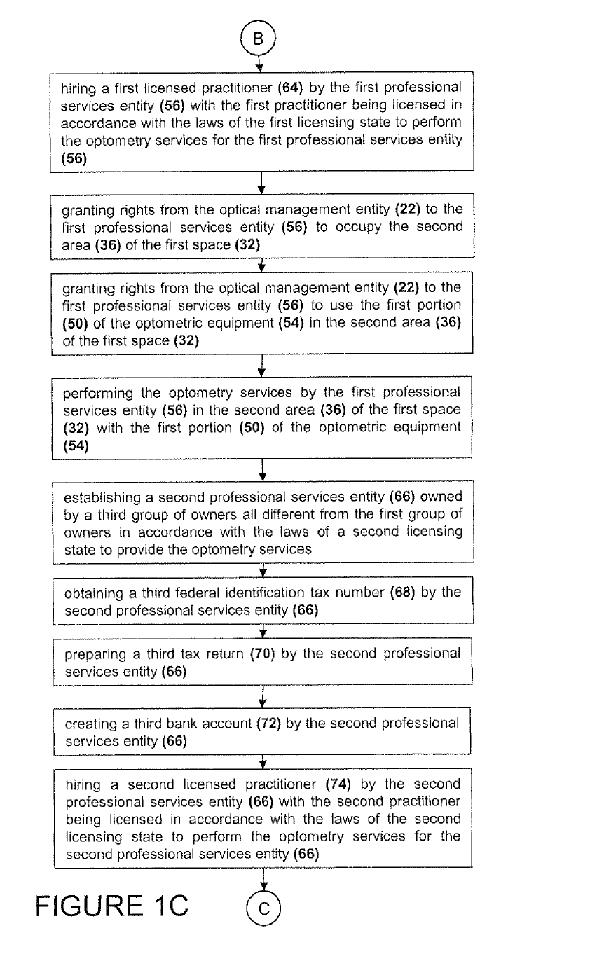

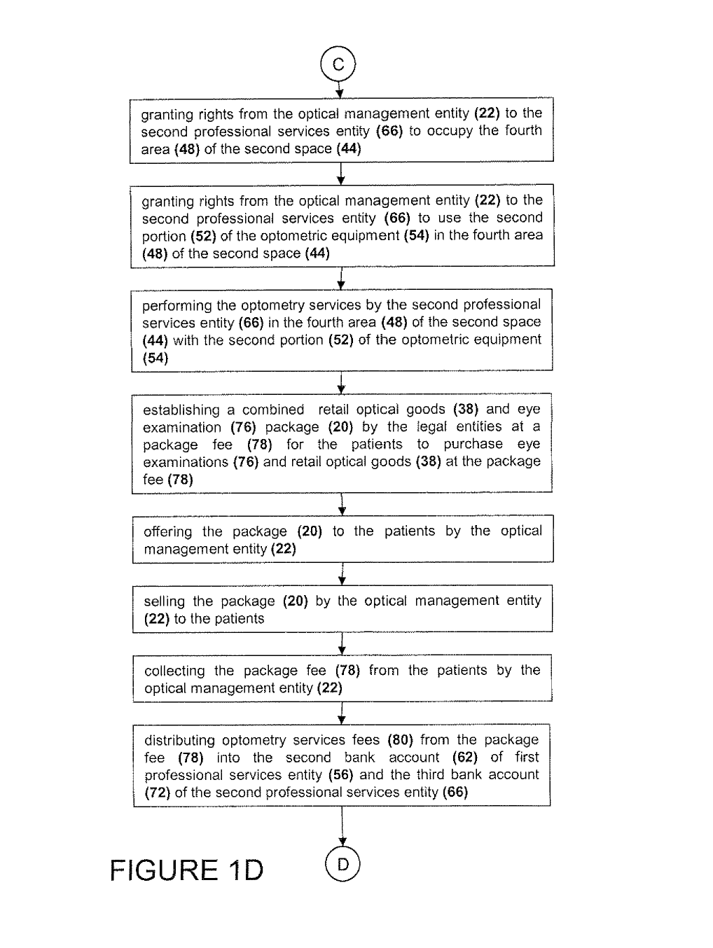

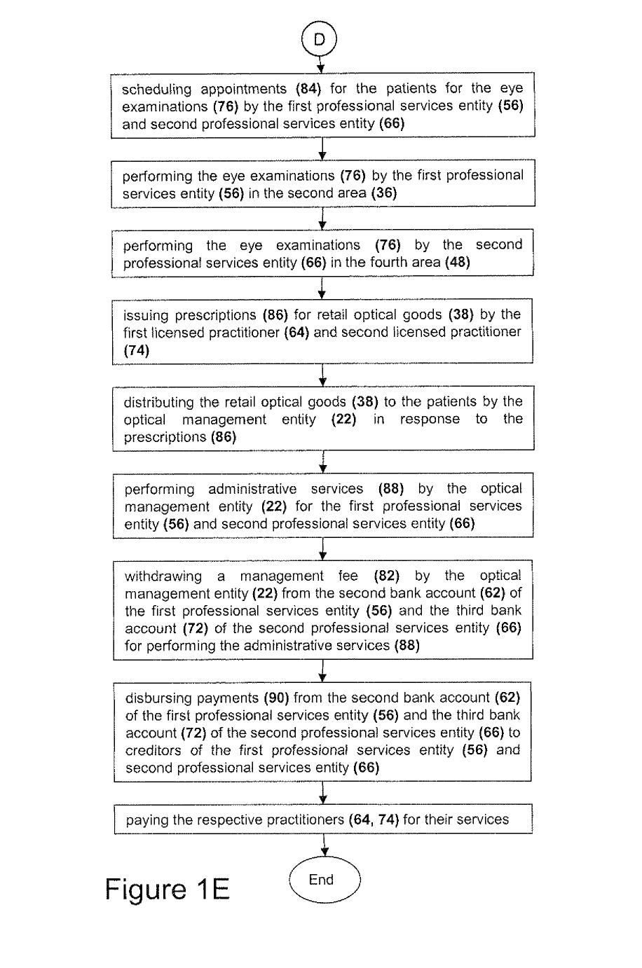

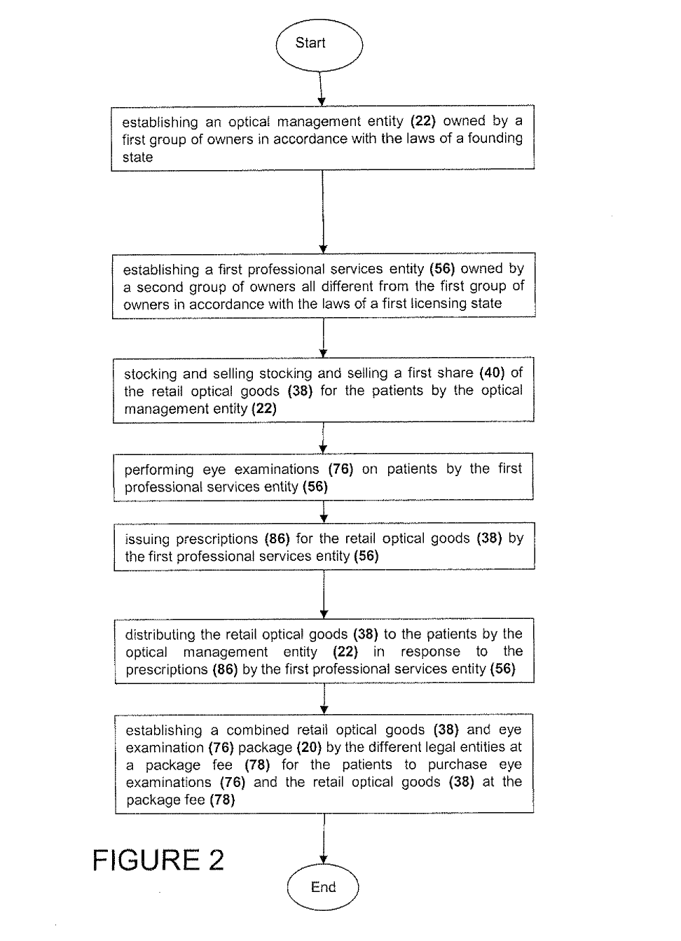

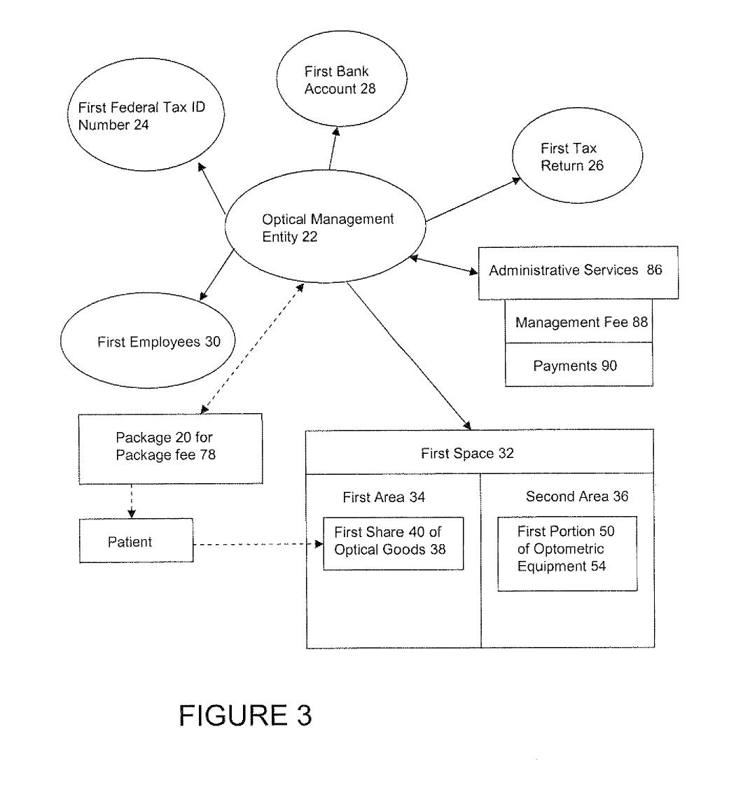

### DETAILED DESCRIPTION

Referring to the Figures, wherein like numerals indicate corresponding parts throughout the several views, a method for providing optometry services and optical goods to patients in a package 20 is shown.

The method starts by establishing an optical management entity 22 owned by a first group of owners in accordance with the laws of a founding state. The optical management entity 22 obtains a first federal identification tax number 24, prepares a first tax return 26, and creates a first bank account 28. The optical management entity 22 then hires and trains a first group of employees 30. Accordingly, the method includes the steps of obtaining a first federal identification tax number 24 by the optical management entity 22, preparing a first tax return 26 by the optical management entity 22, creating a first bank account 28 by the optical management entity 22, and hiring and training a first group of employees 30 by the optical management entity 22.

Next, the optical management entity 22 obtains a first space 32 at a first location to provide a first area 34 and a second area 36 separate from the first area 34. For example, the first space 32 may be in a mall or strip mall in the first location or a first city. Additionally, the first area 34 and second area 36 may be within the same structure and may share a common reception area. The first group of employees 30 of the optical management entity 22 obtain a share of retail optical goods 38 and then stock and sell a first share 40 of the retail optical goods 38 in the first area 34. As such, the method includes the steps of obtaining a first space 32 at a first location by the optical management entity 22 to provide a first area 34 and a second area 36 separate from the first area 34, obtaining shares 40, 42 of retail optical goods 38 by the first group of employees 30 of the optical management entity 22, and stocking and selling a first share 40 of the retail optical goods 38 for the patients in the first area 34 by the first group of employees 30 of the optical management entity 22.

Next, the optical management entity 22 obtains a second space 44 at a second location separate from the first location by the optical management entity 22 to provide a third area 46 and a fourth area 48 separate from the third area 46. For example, the second space 44 may be in a mall or strip mall in the second location separate from the first location or a second city different from the first city. Additionally, the third area 46 and fourth area 48 may be within the same structure and may share a common reception area. The first group of employees 30 of the optical management entity 22 stock and sell a second share 42 of the retail optical goods 38 in the third area 46. Accordingly, the method includes the steps of obtaining a second space 44 at a second location remote from the first location by the optical management entity 22 to provide a third area 46 and a fourth area 48 separate from the third area 46 and stocking and selling a second share 42 of the retail optical goods 38 for the patients in the third area 46 by the first group of employees 30 of the optical management entity 22.

Next, the optical management entity 22 takes possession of portions 50, 52 of optometric equipment 54. The optical management entity 22 then furnishes the second area 36 of the first space 32 with a first portion 50 of the optometric equipment 54 and then furnishes the fourth area 48 of the second space 44 with a second portion 52 of the optometric equipment 54. The first portion 50 and second portion 52 of the optometric equipment 54 is used to perform the optometry services and is typically the same. As such, the method includes the steps of taking possession of portions 50, 52 of optometric equipment 54 by the optical management entity 22, furnishing the second area 36 of the first space 32 with a first portion 50 of the optometric equipment 54, and furnishing the fourth area 48 of the second space 44 with a second portion 52 of the optometric equipment 54.

The next step of the method includes establishing a first professional services entity 56 owned by a second group of owners all different from the first group of owners in accordance with the laws of a first licensing state to provide the optometry services. The first licensing state may be the same state as the founding state or a separate state. The first professional services entity 56 obtains a second federal identification tax number 58, prepares a second tax return 60, and creates a second bank account 62. The first professional services entity 56 then hires a first licensed practitioner 64 with the first practitioner being licensed in accordance with the laws of the first licensing state to perform the optometry services for the first professional services entity 56. Accordingly, the method includes the steps of obtaining a second federal identification tax number 58 by the first professional services entity 56, preparing a second tax return 60 by the first professional services entity 56, creating a second bank account 62 by the first professional services entity 56, and hiring a first licensed practitioner 64 by the first professional services entity 56 with the first practitioner being licensed in accordance with the laws of the first licensing state to perform the optometry services for the first professional services entity 56. The first professional services entity 56 may be owned and operated by a licensed, Board Certified ophthalmologists who serves as the medical director of the first professional services entity 56.

Next, the optical management entity 22 grants rights to the first professional services entity 56 to occupy the second area 36 of the first space 32 and to use the first portion 50 of the optometric equipment 54 in the second area 36 of the first space 32. The first professional services entity 56 performs the optometry services in the second area 36 of the first space 32 with the first portion 50 of the optometric equipment 54. As such, the method includes the steps of granting rights from the optical management entity 22 to the first professional services entity 56 to occupy the second area 36 of the first space 32, granting rights from the optical management entity 22 to the first professional services entity 56 to use the first portion 50 of the optometric equipment 54 in the second area 36 of the first space 32, and performing the optometry services by the first professional services entity 56 in the second area 36 of the first space 32 with the first portion 50 of the optometric equipment 54.

The next step of the method includes establishing a second professional services entity 66 owned by a third group of owners all different from the first group of owners in accordance with the laws of a second licensing state to provide the optometry services. The second licensing state may be the same state as the founding state and first licensing state or a separate state. The second professional services entity 66 obtains a third federal identification tax number 68, prepares a third tax return 70, and creates a third bank account 72. The second professional services entity 66 then hires a second licensed practitioner 74 with the second practitioner being licensed in accordance with the laws of the second licensing state to perform the optometry services for the second professional services entity 66. As such, the method includes obtaining a third federal identification tax number 68 by the second professional services entity 66, preparing a third tax return 70 by the second professional services entity 66, creating a third bank account 72 by the second professional services entity 66, and hiring a second licensed practitioner 74 by the second professional services entity 66 with the second practitioner being licensed in accordance with the laws of the second licensing state to perform the optometry services for the second professional services entity 66. The second professional services entity 66 may be owned and operated by a licensed, Board Certified ophthalmologists who serves as the medical director of the second professional services entity 66. As many legal entities as necessary may be established to work separately with the optical management entity 22.

Next, the optical management entity 22 grants rights from to the second professional services entity 66 to occupy the fourth area 48 of the second space 44 and to use the second portion 52 of the optometric equipment 54 in the fourth area 48 of the second space 44. The second professional services entity 66 performs the optometry services in the fourth area 48 of the second space 44 with the second portion 52 of the optometric equipment 54. Accordingly, the method includes the steps of granting rights from the optical management entity 22 to the second professional services entity 66 to occupy the fourth area 48 of the second space 44, granting rights from the optical management entity 22 to the second professional services entity 66 to use the second portion 52 of the optometric equipment 54 in the fourth area 48 of the second space 44, and performing the optometry services by the second professional services entity 66 in the fourth area 48 of the second space 44 with the second portion 52 of the optometric equipment 54.

Next, the method is distinguished by the step of establishing a combined retail optical goods 38 and eye examination 76 package 20 by the legal entities at a package fee 78 for the patients to purchase eye examinations 76 and retail optical goods 38 at the package fee 78. Examples of such a package 20 includes, en eye exam and two pairs of glasses for the package fee 78 or a group membership for the package fee 78, which may include yearly eye examinations 76 and discounted rates on retail optical goods 38. The package 20 may be established by a committee. The optical management entity 22 and the first professional services entity 56 or second professional services entity 66 may form a committee which is responsible for advising the optical management entity 22 and the first professional services entity 56 or second professional services entity 66 with respect to developing the respective spaces and implementing management and administrative policies for the operation of the respective spaces and providing for dispute resolution on certain matters. The committee may have the following duties: facilitating improvement and expansion; providing marketing and public relations; developing patient fees collection policies, ancillary services, provider and payer relationships, strategic planning, and capital expenditures; and providing fee dispute resolution, grievances referrals, termination of the optical management entity's 22 personnel, and approval of new spaces and dispensary. The committee will not have the ability to make decisions relating to professional health care decisions. Additionally, the recommendations of the committee are intended for advice and guidance only and do not have the power to bind any of the legal entities.

Next, the optical management entity 22 offers the package 20 to the patients, sells the package 20 to the patients, and collects the package fee 78 from the patients. The optical management entity 22 distributes an optometry services fee 80 from the package fee 78 into the second bank account 62 of the first professional services entity 56 and the third bank account 72 of the second professional services entity 66. As such, the method includes the steps of offering the package 20 to the patients by the optical management entity 22, selling the package 20 by the optical management entity 22 to the patients, collecting the package fee 78 from the patients by the optical management entity 22, and distributing optometry services fees 80 from the package fee 78 into the second bank account 62 of the first professional services entity 56 and the third bank account 72 of the second professional services entity 66.

Next, the optical management entity 22 schedules appointments 82 for the patients for the eye examinations 76. The first professional services entity 56 and second professional services entity 66 perform the eye examinations 76 in the second and fourth areas 36, 48 of the first and second spaces 32, 44. The first licensed practitioner 64 of the first professional services entity 56 the and second licensed practitioner 74 of the second professional services entity 66 then issue prescriptions 84 for retail optical goods 38. Next, the optical management entity 22 distributes the optical good to the patients in response to the prescriptions 84. Accordingly, the method includes the steps of scheduling appointments 82 for the patients for the eye examinations 76 by the first professional services entity 56 and second professional services entity 66, performing the eye examinations 76 by the first professional services entity 56 in the second area 36, performing the eye examinations 76 by the second professional services entity 66 in the fourth area 48, issuing prescriptions 84 for retail optical goods 38 by the first licensed practitioner 64 and second licensed practitioner 74, and distributing the retail optical goods 38 to the patients by the optical management entity 22 in response to the prescriptions 84.

Additionally, the optical management entity 22 performs administrative services 86 for the first professional services entity 56 and the second professional services entity 66 and withdraws a management fee 88 from the second bank account 62 of the first professional services entity 56 and the third bank account 72 of the second professional services entity 66 for performing the administrative services 86. As such, the method includes the steps of performing administrative services 86 by the optical management entity 22 for the first professional services entity 56 and the second professional services entity 66 and withdrawing a management fee 88 by the optical management entity 22 from the second bank account 62 of the first professional services entity 56 and the third bank account 72 of the second professional services entity 66 for performing the administrative services 86. Performing the administrative services 86 further includes disbursing payments 90 from the second bank account 62 of the first professional services entity 56 and the third bank account 72 of the second professional services entity 66 to creditors of the first professional services entity 56 and the second professional services entity 66 and paying the respective practitioners 64, 74 for their services. After the steps of the method have been performed the method ends.

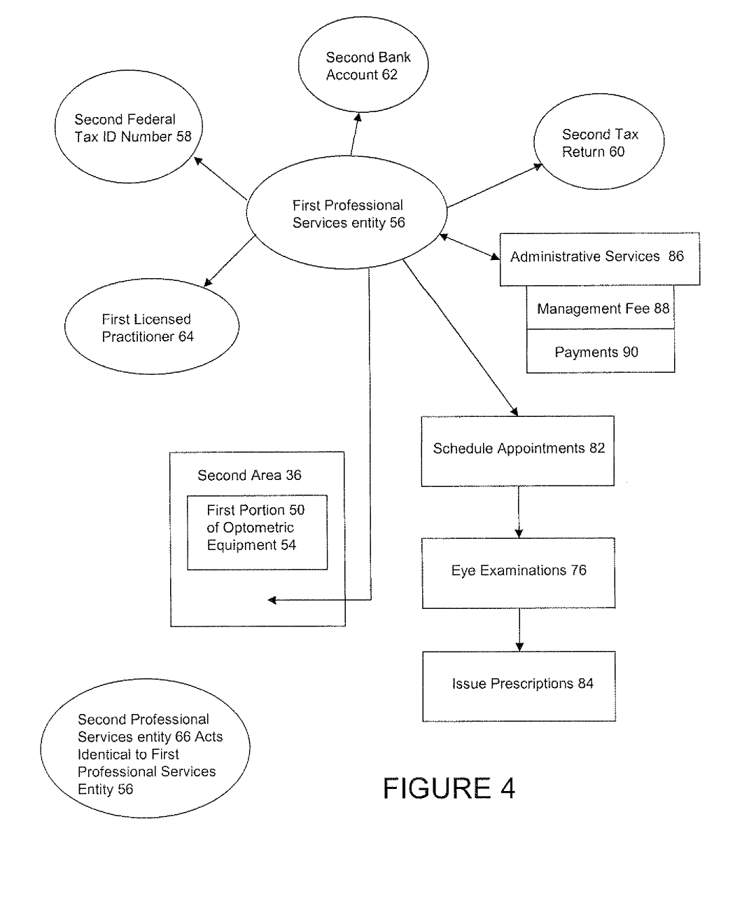

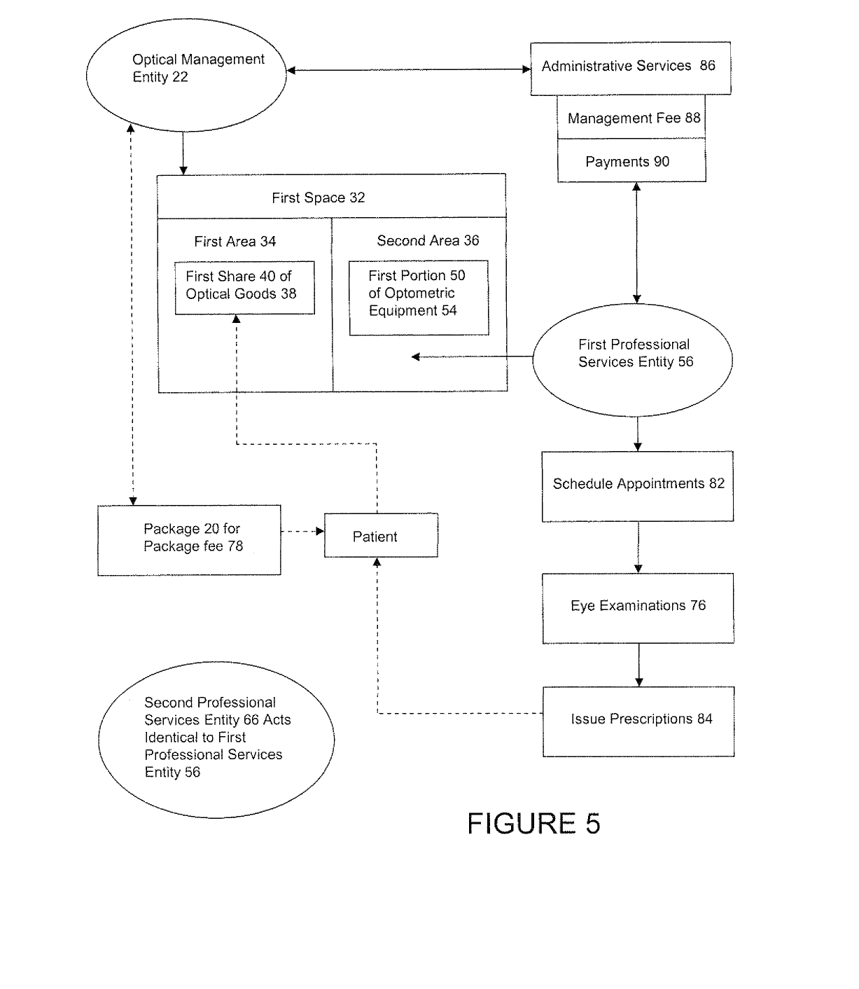

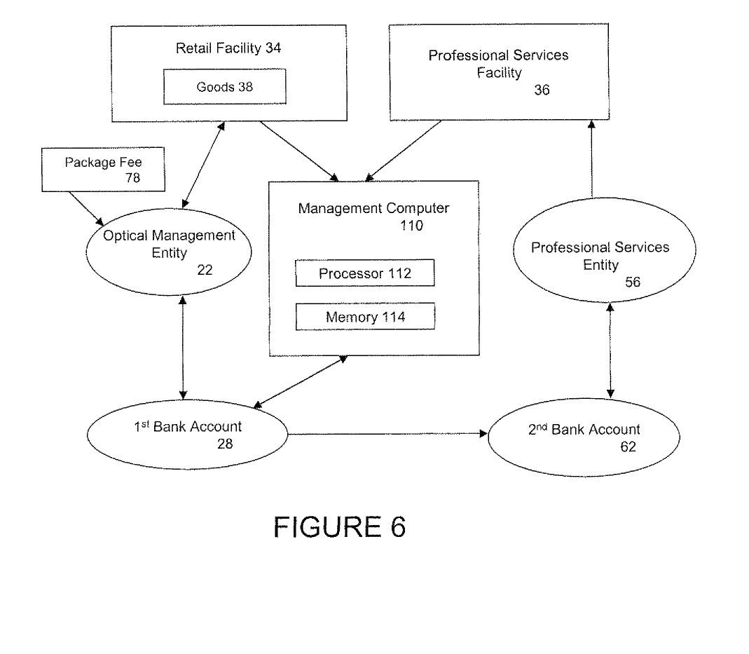

One way of embodying the invention is as a system that provides eye care for patients. Referring to FIG. 6, the system 100 has a retail facility 34 that is stocked with retail optical goods 38. The retail facility 34 is under the operational control of the optical management entity 22 owned by the first ownership group. The system 100 also has a professional services facility 36 that is physically distinct from the retail facility 34. The professional services facility 36 is under the operational control of a professional services entity 56 that is owned by the second group of owners. There is no common membership between the first and second groups of owners. The system 100 also includes a management computer 110, which is a general purpose computer with a processor 112 and memory 114, and which operates software that manages the symbiotic relationship between the optical management entity 22 and the professional services entity 56. The memory 114 of the computer 110 is connected to the processor 112 and bears program code for execution by the processor 112 that causes the processor to perform certain actions. The computer 110 logs deposit, into a bank account 28 of the optical management entity 22, of a payment of a package fee 78 by, or on behalf of, a patient, and it also logs performance, by a professional services entity 56 at the professional services facility 36, of an eye examination on the patient. The computer further logs distribution of prescribed optical goods 38 by the optical management entity 22 to the patient at the retail facility 34. The prescribed optical goods 38 correspond to an ophthalmic prescription 84 (refer to FIG. 4) for the patient issued by the professional services entity 56 at the professional services facility 36 as a result of the eye examination. Part of the package fee 78 is remitted by the computer 110 from the bank account 28 of the optical management entity 22 to a bank account 62 of the professional services entity 56. The remittance 90 corresponds to the performance of an eye examination on the patient, less a management fee 88 (refer to FIG. 4).

Obviously, many modifications and variations of the present invention are possible in light of the above teachings and may be practiced otherwise than as specifically described while within the scope of the appended claims.

What is claimed is:

1. A method for providing optometry services and optical goods to patients in a package (20) comprising:
establishing an optical management entity (22) owned by a first group of owners in accordance with the laws of a founding state,
establishing a first professional services entity (56) owned by a second group of owners all different from the first group of owners in accordance with the laws of a first licensing state,
stocking and selling a first share (40) of the retail optical goods (38) for the patients by the optical management entity (22),
performing eye examinations (76) on patients by the first professional services entity (56),
issuing prescriptions (84) for the retail optical goods (38) by the first professional services entity (56),
distributing the retail optical goods (38) to the patients by the optical management entity (22) in response to the prescriptions (84) by the first professional services entity (56), and
establishing a combined retail optical goods (38) and eye examination (76) package (20) by the different entities (22, 56) at a package fee (78) for the patients to purchase eye examinations (76) and the retail optical goods (38) at the package fee (78).

2. A method as set forth in claim 1 further comprising the steps of:
offering the package (20) to the patients by the optical management entity (22),
selling the package (20) to the patients by optical management entity (22),
collecting the package fee (78) from the patients by the optical management entity (22),
scheduling appointments (82) for the patients for the eye examinations (76) by the first professional services entity (56),
followed by said performing eye examinations (76) on patients by the first professional services entity (56) and issuing prescriptions (84) for the retail optical goods (38) by the first professional services entity (56) steps, and
followed by said distributing the retail optical goods (38) to the patients by the optical management entity (22) in response to the prescriptions (84) by the first professional services entity (56) step.

3. A method as set forth in claim 2 further comprising the steps of:
taking possession of portions (50, 52) of optometric equipment (54) by the optical management entity (22),
granting rights from the optical management entity (22) to the first professional services entity (56) to use a first portion (50) of the optometric equipment (54), and
performing the optometry services with the first portion (50) of the optometric equipment (54) by the first professional services entity (56).

4. A method as set forth in claim 3 further comprising the steps of:
creating a first bank account (28) by the optical management entity (22),
creating a second bank account (62) by the first professional services entity (56), and
distributing optometry services fees (80) from the package fee (78) by the optical management entity (22) into the second bank account (62) of the first professional services entity (56).

5. A method as set forth in claim 4 further comprising the step of hiring a first licensed practitioner (64) by the first professional services entity (56) with the first practitioner being licensed in accordance with the laws of the first licensing state to perform the optometry services for the first professional services entity (56).

6. A method as set forth in claim 5 further comprising the step of performing administrative services (86) by the optical management entity (22) for the first professional services entity (56), including withdrawing a management fee (88) by the optical management entity (22) from the second bank account (62) of the first professional services entity (56) for performing the administrative services (86) and disbursing payments (90) from the second bank account (62) of the first professional services entity (56) to creditors of the first professional services entity (56) and paying the first practitioner for their services.

7. A method as set forth in claim 6 further comprising the steps of:
obtaining a first space (32) at a first location by the optical management entity (22) to provide a first area (34) and a second area (36) separate from the first area (34), and
granting rights from the optical management entity (22) to the first professional services entity (56) to occupy the second area (36) of the first space (32) to provide the optometry services.

8. A method as set forth in claim 7 further comprising the step of hiring and training a first group of employees (30) by the optical management entity (22) to stock and sell the retail optical goods (38) in the first area (34).

9. A method as set forth in claim 8 further comprising the steps of:
obtaining a first federal identification tax number (24) by the optical management entity (22),
preparing a first tax return (26) by the optical management entity (22),
obtaining a second federal identification tax number (58) by the first professional services entity (56), and
preparing a second tax return (60) by the first professional services entity (56).

10. A method as set forth in claim 9 further comprising the step of establishing a second professional services entity (66) owned by a third group of owners all different from the first group of owners in accordance with the laws of a second licensing state to provide the optometry services.

11. A method as set forth in claim 1 further comprising the steps of:
establishing a second professional services entity (66) owned by a third group of owners all different from the first group of owners in accordance with the laws of a second licensing state to provide the optometry services,
stocking and selling a second share (42) of the retail optical goods (38) for the patients by the optical management entity (22),
performing the eye examinations (76) by the second professional services entity (66),
issuing the prescriptions (84) for retail optical goods (38) by the second professional services entity (66), and
distributing the retail optical goods (38) to the patients by the optical management entity (22) in response to the prescriptions (84) by the second professional services entity (66).

12. A method as set forth in claim 11 further comprising the steps of:
offering the package (20) to the patients by the optical management entity (22),
selling the package (20) to the patients by optical management entity (22),
collecting the package fee (78) from the patients by the optical management entity (22),
scheduling appointments (82) for the patients for the eye examinations (76) by the first professional services entity (56),
followed by said performing eye examinations (76) on patients by the first professional services entity (56) and issuing prescriptions (84) for the retail optical goods (38) by the first professional services entity (56) steps,
followed by said distributing the retail optical goods (38) to the patients by the optical management entity (22) in response to the prescriptions (84) by the first professional services entity (56) step,
scheduling appointments (82) for the patients for the eye examinations (76) by the second professional services entity (66),
followed by said performing eye examinations (76) on patients by the second professional services entity (66) and issuing prescriptions (84) for the retail optical goods (38) by the second professional services entity (66) steps, and
followed by said distributing the retail optical goods (38) to the patients by the optical management entity (22) in response to the prescriptions (84) by the second professional services entity (66) step.

13. A method as set forth in claim 12 further comprising the steps of:
taking possession of portions (50, 52) of optometric equipment (54) by the optical management entity (22),
granting rights from the optical management entity (22) to the first professional services entity (56) to use a first portion (50) of the optometric equipment (54),
performing the optometry services with the first portion (50) of the optometric equipment (54) by the first professional services entity (56),
granting rights from the optical management entity (22) to the second professional services entity (66) to use a second portion (52) of the optometric equipment (54), and
performing the optometry services by the second professional services entity (66) with the second portion (52) of the optometric equipment (54).

14. A method as set forth in claim 13 further comprising the steps of;
creating a first bank account (28) by the optical management entity (22),
creating a second bank account (62) by the first professional services entity (56),
creating a third bank account (72) by the second professional services entity (66), and
distributing the optometry services fees (80) from the package fee (78) by the optical management entity (22) into the second bank account (62) of the first professional services entity (56) and the third bank account (72) of the second professional services entity (66).

15. A method as set forth in claim 14 further comprising the steps of:
hiring a first licensed practitioner (64) by the first professional services entity (56) with the first practitioner being licensed in accordance with the laws of the first licensing state to perform the optometry services for the first professional services entity (56), and
hiring a second licensed practitioner (74) by the second professional services entity (66) with the second practitioner being licensed in accordance with the laws of the second licensing state to perform the optometry services for the second professional services entity (66).

16. A method as set forth in claim 15 further comprising the step of performing administrative services (86) by the optical management entity (22) for both the first professional services entity (56) and the second professional services entity (66), including withdrawing a management fee (88) by the optical management entity (22) from the second bank account (62) of the first professional services entity (56) and the third bank account (72) of the second professional services entity (66) for performing the administrative services (86) and disbursing payments (90) from the second bank account (62) of the first professional services entity (56) and the third bank account (72) of the second professional services entity (66) to the respective creditors of the first professional services entity (56) and second professional services entity (66) and paying the first licensed practitioner (64) and second practitioner for their services.

17. A method as set forth in claim 16 further comprising the steps of:
obtaining a first space (32) at a first location by the optical management entity (22) to provide a first area (34) and a second area (36) separate from the first area (34),
granting rights from the optical management entity (22) to the first professional services entity (56) to occupy the second area (36) of the first space (32) to provide the optometry services,
obtaining a second space (44) at a second location remote from the first location by the optical management entity (22) to provide a third area (46) and a fourth area (48) separate from the third area (46), and
granting rights from the optical management entity (22) to the second professional services entity (66) to occupy the fourth area (48) of the second space (44) to provide optometry services.

18. A method as set forth in claim 17 further comprising the step of hiring and training a first group of employees (30) by the optical management entity (22) to stock and sell the retail optical goods (38) in the first and third areas (34, 46).

19. A method as set forth in claim 18 further comprising the steps of:
obtaining a first federal identification tax number (24) by the optical management entity (22),
preparing a first tax return (26) by the optical management entity (22),
obtaining a second federal identification tax number (58) by the first professional services entity (56),
preparing a second tax return (60) by the first professional services entity (56),
obtaining a third federal identification tax number (68) by the second professional services entity (66), and
preparing a third tax return (70) by the second professional services entity (66).

20. A method as set forth in claim 19 wherein the founding state, the first licensing state and the second licensing state are the same state.

21. A method for providing optometry services and optical goods to patients in a package (20) comprising:
establishing an optical management entity (22) owned by a first group of owners in accordance with the laws of a founding state,
obtaining a first federal identification tax number (24) by the optical management entity (22),
preparing a first tax return (26) by the optical management entity (22),
creating a first bank account (28) by the optical management entity (22),
hiring and training a first group of employees (30) by the optical management entity (22),
obtaining a first space (32) at a first location by the optical management entity (22) to provide a first area (34) and a second area (36) separate from the first area (34),
obtaining shares (40, 42) of retail optical goods (38) by the first group of employees (30) of the optical management entity (22),
stocking and selling a first share (40) of the retail optical goods (38) for the patients in the first area (34) by the first group of employees (30) of the optical management entity (22),
obtaining a second space (44) at a second location remote from the first location by the optical management entity (22) to provide a third area (46) and a fourth area (48) separate from the third area (46),
stocking and selling a second share (42) of the retail optical goods (38) for the patients in the third area (46) by the first group of employees (30) of the optical management entity (22),
taking possession of portions (50, 52) of optometric equipment (54) by the optical management entity (22),
furnishing the second area (36) of the first space (32) with a first portion (50) of the optometric equipment (54),
furnishing the fourth area (48) of the second space (44) with a second portion (52) of the optometric equipment (54),
establishing a first professional services entity (56) owned by a second group of owners all different from the first group of owners in accordance with the laws of a first licensing state to provide the optometry services,
obtaining a second federal identification tax number (58) by the first professional services entity (56),
preparing a second tax return (60) by the first professional services entity (56),
creating a second bank account (62) by the first professional services entity (56),
hiring a first licensed practitioner (64) by the first professional services entity (56) with the first practitioner being licensed in accordance with the laws of the first licensing state to perform the optometry services for the first professional services entity (56),
granting rights from the optical management entity (22) to the first professional services entity (56) to occupy the second area (36) of the first space (32),
granting rights from the optical management entity (22) to the first professional services entity (56) to use the first portion (50) of the optometric equipment (54) in the second area (36) of the first space (32),
performing the optometry services by the first professional services entity (56) in the second area (36) of the first space (32) with the first portion (50) of the optometric equipment (54),
establishing a second professional services entity (66) owned by a third group of owners all different from the first group of owners in accordance with the laws of a second licensing state to provide the optometry services,
obtaining a third federal identification tax number (68) by the second professional services entity (66),
preparing a third tax return (70) by the second professional services entity (66),
creating a third bank account (72) by the second professional services entity (66),
hiring a second licensed practitioner (74) by the second professional services entity (66) with the second practitioner being licensed in accordance with the laws of the second licensing state to perform the optometry services for the second professional services entity (66),
granting rights from the optical management entity (22) to the second professional services entity (66) to occupy the fourth area (48) of the second space (44),
granting rights from the optical management entity (22) to the second professional services entity (66) to use the second portion (52) of the optometric equipment (54) in the fourth area (48) of the second space (44),
performing the optometry services by the second professional services entity (66) in the fourth area (48) of the second space (44) with the second portion (52) of the optometric equipment (54),
establishing a combined retail optical goods (38) and eye examination (76) package (20) by the legal entities at a package fee (78) for the patients to purchase eye examinations (76) and retail optical goods (38) at the package fee (78),
offering the package (20) to the patients by the optical management entity (22),
selling the package (20) by the optical management entity (22) to the patients,
collecting the package fee (78) from the patients by the optical management entity (22),
distributing optometry services fees (80) from the package fee (78) into the second bank account (62) of the first professional services entity (56) and the third bank account (72) of the second professional services entity (66),
scheduling appointments (82) for the patients for the eye examinations (76) by the first professional services entity (56) and second professional services entity (66),
performing the eye examinations (76) by the first professional services entity (56) in the second area (36),
performing the eye examinations (76) by the second professional services entity (66) in the fourth area (48),
issuing prescriptions (84) for retail optical goods (38) by the first licensed practitioner (64) and second licensed practitioner (74),
distributing the retail optical goods (38) to the patients by the optical management entity (22) in response to the prescriptions (84),
performing administrative services (86) by the optical management entity (22) for the first professional services entity (56) and the second professional services entity (66),
withdrawing a management fee (88) by the optical management entity (22) from the second bank account (62) of the first professional services entity (56) and the third bank account (72) of the second professional services entity (66) for performing the administrative services (86), and
performing administrative services (86) further includes disbursing payments (90) from the second bank account (62) of the first professional services entity (56) and the third bank account (72) of the second professional services entity (66) to creditors of the first professional services entity (56) and the second professional services entity (66) and paying the respective practitioners (64, 74) for their services.

22. A system (100) for providing eye care for a patient, the system comprising:
a retail facility (34) stocked with retail optical goods (38), the retail facility (34) being under the operational control of an optical management entity (22) owned a first ownership group;
a professional services facility (36) physically distinct from the retail facility (34), the professional services facility (36) being under the operational control of a professional services entity (56) owned by a second group of owners, wherein there is no common membership between the first and second groups of owners; and
a general purpose computer (110) comprising:
a processor (112); and
a memory (114) connected to the processor (112) and bearing program code for execution by the processor (112), the program code causing the processor (112) to perform the actions:
logging deposit, into a bank account (28) of the optical management entity (22), of a payment of a package fee (78) by, or on behalf of, the patient;
logging performance, by a professional services entity (56) at the professional services facility (36), of an eye examination on the patient;
logging distribution of prescribed optical goods (38) by the optical management entity (22) to the patient at the retail facility (34), the prescribed optical goods (38) corresponding to at least one ophthalmic prescription for the patient issued by the professional services entity (56) at the professional services facility (36) as a result of the eye examination; and
remitting part of the package fee (78), from the bank account (28) of the optical management entity (22) as payment (90) to a bank account (62) of the professional services entity (56), corresponding to the performance of an eye examination on the patient, less a management fee (88).

23. A system (100) as set forth in claim 22, wherein the retail facility (34) and the professional services facility (36) are located substantially adjacent one another while maintaining physical distinctness.
